(19) United States
(12) Patent Application Publication
(10) Pub. No.: US 2004/0190096 A1
(43) Pub. Date: Sep. 30, 2004

(54) Mirror, mirror holder, and light scanning device using same

(76) Inventor: Yoshiyuki Takase, Oyama City (JP)

Correspondence Address: Arnold International, P.O. BOX 129, Great Falls, VA, 22066, US

(21) Appl. No.: 10/801,659

(22) Filed: Mar. 17, 2004

(30) Foreign Application Priority Data
Mar. 31, 2003 (JP) 2003-093016

(51) Int. Cl. G02B 26/08; G02B 7/182

(52) U.S. Cl. 359/196; 359/871

(57) ABSTRACT

An elongated mirror is held in a mirror holder that protects the top, bottom, and back sides, as well as the two ends, of a mirror. The mirror holder includes a means for bending the mirror and a means for adjusting the amount of bending of the mirror so that it can be flexed at a central portion in a width direction that is perpendicular to the longitudinal direction of the mirror. The means for adjusting the amount of bending can be a screw that presses a plate with a planar surface against the upper edge of the mirror. The plate is L-shaped with one leg of the L shape forming the planar surface that presses against the mirror and the other leg of the L shape engaging a hole in the mirror holder. The elongated mirror may be a cylindrical mirror of a light scanning device.

### BACKGROUND OF THE INVENTION

In an image-forming apparatus such as a copier, printer, or similar device, a picture is reproduced or generated on a transfer medium such as PPC paper from image data using a light scanning device to form an image of the picture. In the light scanning device, a laser light beam is modulated with image information. The modulated laser light beam is adjusted, for example, by collimating and converging the light beam, and is made incident on a deflection device, such as a polygon mirror. After deflection from the deflection device, the laser light beam scans a photoreceptor drum by sequentially changing the position of the laser light beam on the photoreceptor drum in a first direction that is called the main scanning direction in order to form an electrostatic latent image on the photoreceptor drum. Moreover, the photoreceptor drum is rotated during scanning in order to move the surface of the photoreceptor drum where a latent image is being formed by scanning so that the surface of the photoreceptor drum moves in what is called the subscanning direction. After the image is scanned, an electrostatic image is formed and developed with toner to form a toner image. This toner image is transferred to the transfer medium in order to produce a picture based on the image data.

In recent years, color copiers and color printers that reproduce an original image very faithfully have become popular. In light scanning devices used in such color printers, for example, each of four laser sources emits laser light that contains image information corresponding to a different one of four colors, such as, yellow, magenta, cyan, and black. The four laser light beams are incident on a common deflection device and deflected in different directions to four different mirrors that reflect the light beams to four different photoreceptor drums that are positioned side by side. An electrostatic latent image with different image information is formed on each photoreceptor drum. The electrostatic latent images are developed with toner, and the toner images are sequentially transferred to form color images while moving the transfer medium in the direction in which the photoreceptor drums are arranged.

In image-forming apparatuses for producing color images, miniaturization and faster image production have been increasingly required, including reduction of the space for optical components in the optical path between the laser sources and the photoreceptor drums, which form light scanning devices.

Japanese Laid-Open Patent Application 2001-154135 discloses a conventional light scanning device for miniaturizing such image forming apparatuses. FIG. 8 shows a schematic side view of the conventional light scanning device with some light paths indicated. As shown in FIG. 8, the image-forming device includes a laser source 52, a collimator lens 53, and a cylindrical lens 54 for adjusting light beams from the laser source 52, and are arranged on the underside of a chassis 51. A laser light beam is emitted at an angle upwardly through the collimator lens 53 and the cylindrical lens 54 and is reflected by a folding mirror 57 onto a polygon mirror 55, which is the deflection device. The light beam incident on the polygon mirror 55 and reflected by the polygon mirror 55 remains in a plane perpendicular to the axis of rotation of the polygon mirror 55, i.e., the plane that includes the tangential direction of movement of the facet surface of the polygon mirror 55 that deflects the light beam. Thus, in the schematic side view of FIG. 8, the direction of the light beam incident on the polygon mirror 55 appears to be perpendicular to the facet end surfaces of the polygon mirror 55 and to the axis of rotation of the polygon mirror 55. The polygon mirror 55 reflects the laser light to an f·θ lens 56 mounted on the chassis 51.

In order to achieve further miniaturization, limitations on the placement of the laser sources arise, and it becomes necessary that laser light beams be incident on the deflection device, Such as the polygon mirror 55, from a direction that does not lie in a plane perpendicular to the axis of rotation of the polygon mirror 55. FIGS. 9A and 9B show side views of deflection devices and incident light beams from the same perspective as FIG. 8. FIG. 9A shows a side view of a deflection device with four incident light beams L, each of which lies in a plane perpendicular to the axis of rotation, defined by the rotary shaft of polygon mirror 55, and that therefore also includes the tangential direction of movement of the deflecting surface, that is, the facet surface of the polygon mirror 55, that deflects the light beam. The four light beams L are parallel to one another and appear to strike a facet surface of the polygon mirror 55 perpendicularly. FIG. 9B shows a side view of a deflection device with two incident light beams L, each of which lies in a plane perpendicular to the axis of rotation, defined by the rotary shaft of the polygon mirror 55, and that therefore also includes the tangential direction of movement of the deflecting surface, that is, the facet surface of polygon mirror 55, that deflects the light beam. However, FIG. 9B also shows two incident light beams L neither of which lies in a plane perpendicular to the axis of rotation of the polygon mirror 55. As shown in FIG. 9B, the latter two incident light beams appear to be on converging paths before striking a facet of the polygon mirror 55 and they strike the facet obliquely rather than perpendicularly as seen in FIG. 9B. An incident light beam that does not lie in a plane perpendicular to the axis of rotation of the deflecting device and that is incident on the deflecting surface obliquely as seen in FIG. 9B is herein defined as incident “in an oblique direction” on the deflecting surface.

The four light beams shown in FIG. 9A and the two parallel light beams shown in FIG. 9B are not incident in an oblique direction on the polygon mirror 55, as “in an oblique direction” herein defined, even though as the polygon mirror 55 rotates their angles of incidence vary. That is, light beams that appear to travel in a direction perpendicular to the axis of rotation of the polygon mirror 55 in FIGS. 9A and 9B are never incident in an oblique direction on the deflecting device as the phrase “in an oblique direction” is herein defined.

As a comparison of FIG. 9A and FIG. 9B indicates, the deflection device can be made thinner by at least one of the light beams being incident in an oblique direction. For example, a color image may be formed with four laser light beams L that are parallel to one another and in planes perpendicular to the direction of the rotary shaft of the polygon mirror 55, as shown in FIG. 9A. As shown in FIG. 9A, the four laser light beams L have equal path lengths and remain slightly separated from one another so that the polygon mirror 55 must be thick in order to reflect all four light beams. In contrast, as shown in FIG. 9B, when two of the light beams L are incident in an oblique direction, only one separation distance of the light beams L exists at the surface of the polygon mirror 55 and therefore the polygon mirror 55 can be thinner. Moreover, if the structure shown in FIG. 8 is modified to include light beams that strike the deflecting device in an oblique direction, mirror 57 can be moved to a lower position than that shown in FIG. 8 relative to the polygon mirror 55. That enables the light scanning device to be made even thinner.

However, if one or more laser light beams is made incident in an oblique direction, as shown in FIG. 9B, the following problems may arise. The laser light beams are deflected by the deflection device, such as a polygon mirror as described above, to the f·θ lens that is designed to make the laser beams scan linearly at a constant speed. However, a laser beam may not scan in a straight line as intended but may follow a curve, a phenomenon known as “bow.” Particularly, as with a color printer, the four scanning light beams may not coincide at a transfer medium to form a distinct image because of bow. Bow has previously been handled by guiding the laser light beams to the photoreceptor drum by accurately positioning the folding mirror 57 shown in FIG. 8. However, the optical path from the laser source to the photoreceptor drum must be adjusted with precise placement of all of the optical components that determine the optical paths of the laser light beams. If the positioning of the folding mirror 57 is even slightly wrong, the desired correction of bow cannot be achieved and an indistinct picture is produced. Especially for a laser light beam incident in an oblique direction, the bow may be particularly large. Therefore, a simple way to correct for bow is desired.

### BRIEF SUMMARY OF THE INVENTION

The present inventions relates to a mirror and mirror holder, and a light scanning device using the mirror and mirror holder that can correct bow, that is, the phenomenon of an undesirably curved scanning line of the scanning light beam. The present invention further relates to such a light scanning device for use in an image-forming apparatus in which light modulated with image information is incident on a rotating photoreceptor drum, with scanning of the laser light beam producing an electrostatic latent image on the photoreceptor drum and with this electrostatic latent image being processed in order to produce an image on PPC paper or a similar medium that is a more faithful and distinct replica of an original image.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is a cross-sectional view of a mirror and mirror holder according to the present invention taken along the line A-A of FIG. 2;

FIG. 2 is a schematic front view of a mirror and mirror holder according to the present invention;

FIG. 3 is a schematic top view of portions of the mirror and mirror holder of FIG. 2;

FIG. 4 is a schematic cross-sectional top view of portions of the mirror and mirror holder of FIG. 2;

FIG. 5 is a perspective view of a light scanning device that may include the present invention;

FIG. 6 shows a front view of a cylindrical mirror that illustrates bow;

FIGS. 7A-7B show cross-sectional views of central portions of a conventional cylindrical mirror and photoreceptor drum arrangement and a cylindrical mirror and photoreceptor drum arrangement according to the present invention, respectively;

FIG. 8 shows a schematic side view of a conventional light scanning device with some light paths indicated; and

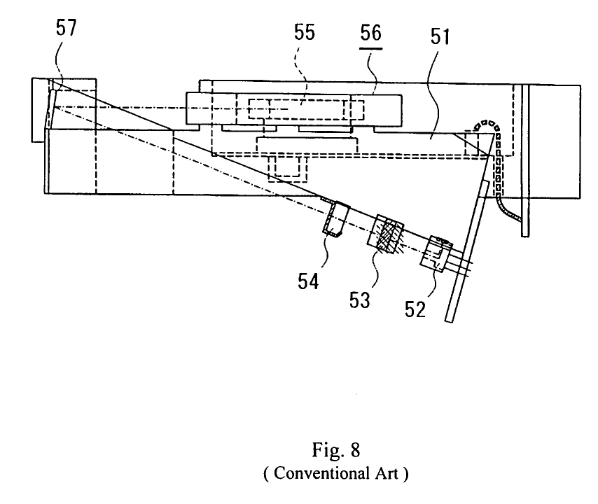

FIGS. 9A-9B show side views of deflection devices and incident laser light beams that are all parallel and that are not all parallel, respectively.

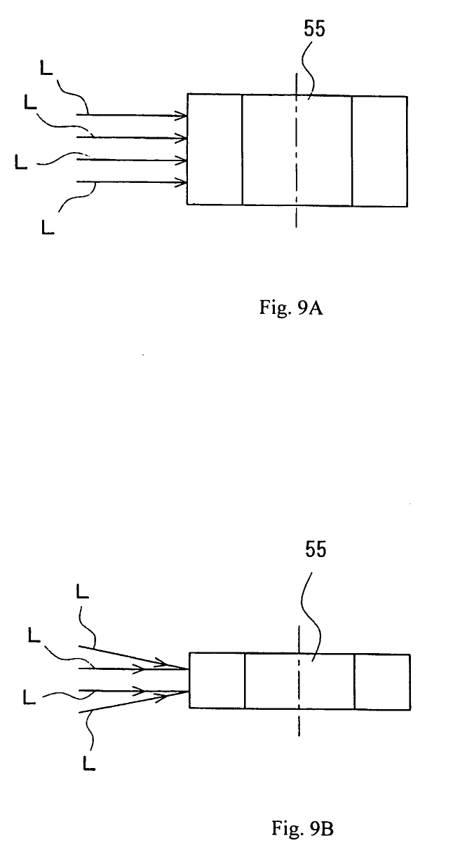

### DETAILED DESCRIPTION OF THE INVENTION

A preferred embodiment of the light scanning device of the present invention will now be described with reference to the drawings.

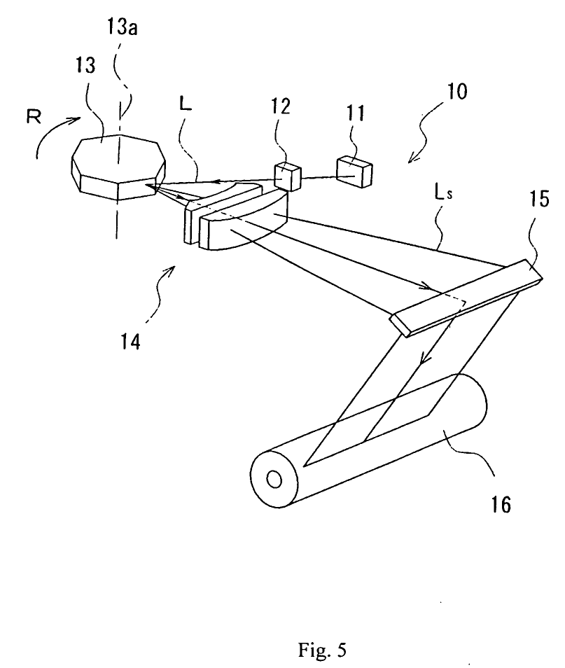

FIG. 5 is a perspective view of a light scanning device 10 that may include the present invention. The light scanning device 10 includes a laser light source 11 that generates a laser light beam L containing image information based on image data, a beam adjusting optical system 12 that includes a collimator lens or a cylindrical lens used to adjust the laser light beam L to a desired collimated or converging state, a polygon mirror 13 that operates as a deflection device for the laser light beam L that has been adjusted by the beam adjusting optical system 12, an f·θ lens 14 that receives the laser light beam L reflected by the polygon mirror 13, a mirror 15 with a cylindrical reflecting surface, generally termed a cylindrical mirror, that reflects light transmitted by the f·θ lens 14 as a scanning line in prescribed directions, and a photoreceptor drum 16 that is scanned in order to form an electrostatic latent image on its surface. The polygon mirror 13 is formed into a regular polygonal column with reflective side surfaces or facets and is rotated at a constant speed about a shaft 13a. The laser light beam L emitted from the laser light source 11 and adjusted by the beam adjusting optical system 12 is incident on a side surface of the polygon mirror 13 and is reflected in different directions as the polygon mirror 13 rotates. The laser light beam L is incident in an oblique direction onto the polygon mirror 13, that is, the laser light beam L does not lie in a plane perpendicular to the axis of rotation defined by the shaft 13a of the polygon mirror 13, namely, the plane that includes the tangential direction of movement of the facet surface of the polygon mirror 13. As explained previously, having the laser light beam L incident in an oblique direction allows the polygon mirror to be made thinner in the direction of its axis of rotation.

Although a single laser light beam L is shown in FIG. 5, in a light scanning device incorporated into an image-forming apparatus, such as a laser printer or similar device, four laser light beams are arrayed near one another in order to be incident on the same side surface of the polygon mirror 13. Additionally, a separation optical system (not shown in the drawings) is used to separate the four laser light beams after they pass through the f·θ lens 14 before they are incident on the photoreceptor drum 16.

The f·θ lens operates to assure that the laser light beam L is adjusted so that its direction changes at a constant rate so that its point of scan on the photoreceptor drum 16 moves at a constant, or nearly constant speed. The moving locus of the light beam Ls becomes a scanning line S_{L} in the main scanning direction that is incident onto the cylindrical mirror 15. The cylindrical mirror 15 reflects the incident scanning light beam Ls to the photoreceptor drum 16. In a color light scanning device having multiple laser light beams, the separation optical system may include separate mirrors for separating the laser light beams before they strike the cylindrical mirror 15.

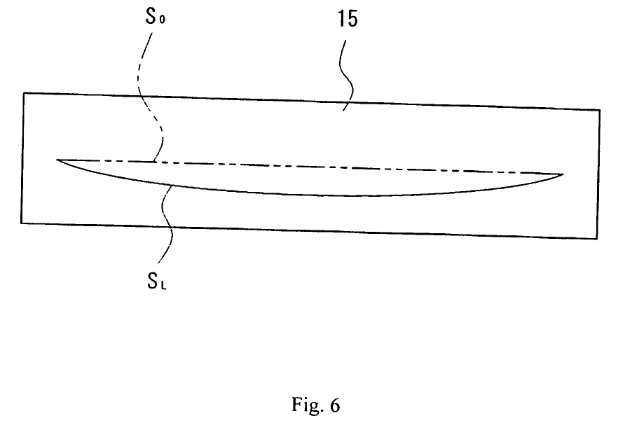

The laser light beam L emitted from the laser light source 11 and incident in an oblique direction on the polygon mirror 13 is also reflected in an oblique direction from the polygon mirror 13. Therefore, the scanning laser light beam transmitted by the f·θ lens 14 does not produce a straight scanning line. FIG. 6 shows a front view of the cylindrical mirror 15 with the scanning line S_{L} produced by the scanning light beam Ls shown as a solid curved line. An imaginary, ideal straight scanning line S₀ is also shown in FIG. 6. The bow caused by the laser light beam Ls being incident obliquely onto the polygon mirror 13 is apparent by viewing the scanning line S₁ in FIG. 6. If the scanning light beam Ls (FIG. 5) is incident onto the cylindrical mirror 15 with bow, the incident position of the scanning light beam Ls varies in the width direction (i.e., the vertical dimension in FIG. 5) of the cylindrical mirror 15 along the scanning line S_{L}, and also the incident angle varies in the longitudinal direction of the cylindrical mirror 15. Therefore, the scanning line S_{L} produced by the scanning light beam that is reflected by the cylindrical mirror 15 onto the photoreceptor drum will not be a straight line as desired, but will also have a bow.

The moving direction of the scanning light beam Ls is the main scanning direction, which is the longitudinal direction, that is, the direction along the length or longer dimension of the cylindrical mirror 15. The width direction of the cylindrical mirror 15 is perpendicular to the longitudinal direction across the reflecting surface of the cylindrical mirror 15, and the width direction is imaged in the subscanning direction in which the object to be scanned moves, which is particularly the direction of rotational movement of the photoreceptor drum 16 where the scanning light beam Ls is incident. The longitudinal direction and the width direction perpendicular to the longitudinal direction define a plane perpendicular to a normal to the reflecting surface of the cylindrical mirror. Based on symmetry of the cylindrical mirror, that normal may be at the center of the cylindrical mirror in both the longitudinal and width directions of the cylindrical mirror.

The bow occurs relative to the main scanning direction. As described above, a scanning light beam with the bow is incident to the cylindrical mirror because the laser light reflected by the polygon mirror is obliquely incidental to the f·θ lens 14. If a planar mirror were placed in the position of the cylindrical mirror 15, the bow on the photoreceptor drum would be the same as the bow on the planar mirror. If a cylindrical mirror 15 were shaped so its locus of deepest concavity followed the shape of the bow instead of the longitudinal direction, a bow similar to that obtained using a planar mirror would result. However, if the locus of deepest concavity deviates slightly from the shape of the bow, the reflection point of the laser light and the angle of reflection from the cylindrical mirror 15 change. In order to scan a straight line on the photoreceptor drum 16, the shape of the cylindrical mirror 15 must be properly adjusted. Both the reflection point on the cylindrical mirror 15 and the angle of reflection on the cylindrical mirror 15 affect the scanning line on the photoreceptor drum 16. In the present invention, the middle of the cylindrical mirror 15 in its longitudinal direction is pressed in its width direction and the cylindrical mirror 15 is made flexible enough to respond to pressure in the width direction in order to change the portion of the cylindrical mirror 15 that is struck by the light beam as the light beam scans generally in the longitudinal direction of the cylindrical mirror. The flexure of the cylindrical mirror 15 may adjust not only for bow introduced by the laser light beam being incident in an oblique direction but also bow introduced by manufacturing and assembly errors of the optical components of the image scanning device.

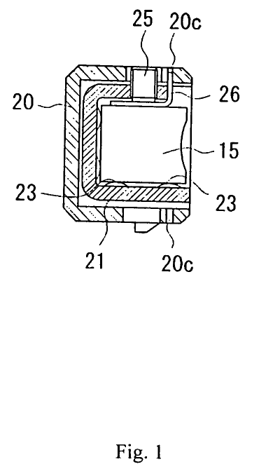

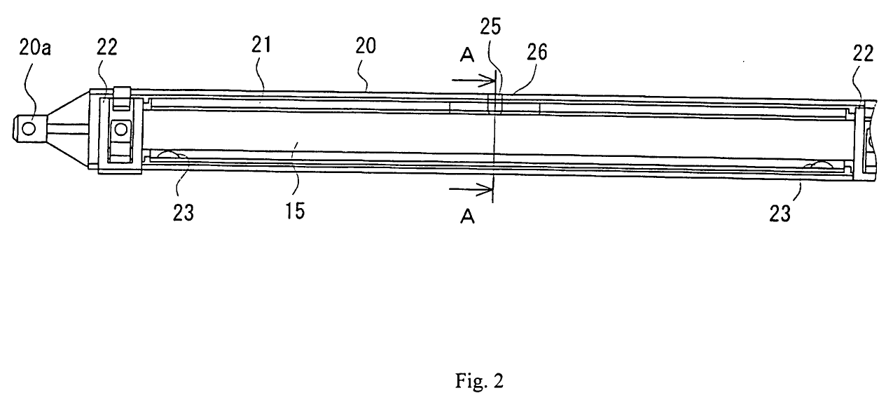

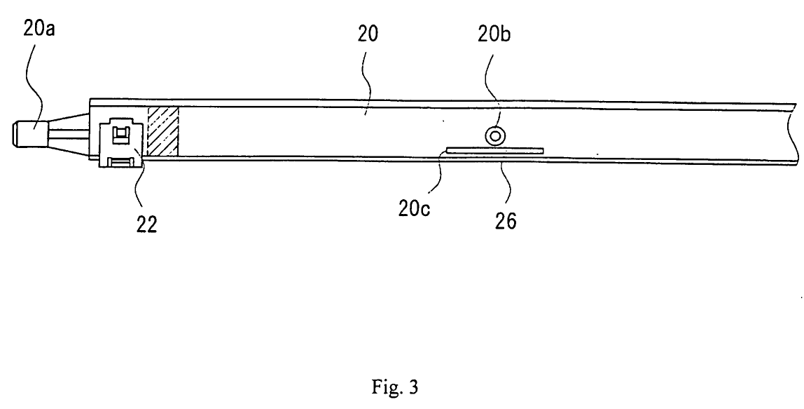

FIGS. 1-4 show structures for inhibiting bow, that is, the curving of the scanning line S_{L} that is incident on photoreceptor drum 16 that may occur due to bow that is present in the scanning light beam Ls at the cylindrical mirror 15. More specifically, the structures are support structures for the cylindrical mirror. As shown in FIGS. 1-4, the cylindrical mirror 15 is received within a mirror holder 20 which protects the mirror on the top, bottom and back sides as well as on both ends and exposes only one side of the cylindrical mirror 15, namely, the reflecting surface. The cylindrical mirror 15 is held in a holding frame 21 with a nearly U-shaped cross-section that is received in the mirror holder 20. As shown in FIGS. 2 and 3, a pressing member 22 embraces the mirror holder 20 from the front of the mirror holder 20 at both longitudinal ends of the cylindrical mirror 15 in order to hold the cylindrical mirror 15 so that it does not come out of the mirror holder 20. Moreover, a support rod 20a protrudes from each end of the mirror holder 20 for mounting in a chassis (not illustrated).

The mirror holder 20 is equipped with an adjustment mechanism as disclosed in Japanese Laid-Open Patent Application 2001-356259 which enables the incident position of the laser light beam to be changed by rotating the mirror holder 20 about the support rod 20a so as to make an adjustment of inclination, and the relative positions of both ends of the mirror holder 20 can be changed to make an adjustment of skew. In addition, according to the present invention, the mirror holder 20 contains a means for bending the cylindrical mirror 15, as well as a means for adjusting the amount of bending of the cylindrical mirror 15, in a direction normal to its reflecting surface so as to adjust the magnification of the cylindrical mirror. Image formation on the surface of a photoreceptor drum 16 can be improved by making proper adjustments of magnification, inclination, and skew.

As shown in FIGS. 1 and 2, projections 23, which are a part of the inner wall surfaces of the holding frame 21 and which support the cylindrical mirror 15 in positions facing both ends of the cylindrical mirror 15, are provided. Additional projections (not shown in the drawings), which are a part of the holding frame 21 and support the back of the cylindrical mirror 15 in positions facing both ends of the cylindrical mirror 15 on the reverse face, are also provided. Thus, cylindrical mirror 15 is supported by point contacts of the projections.

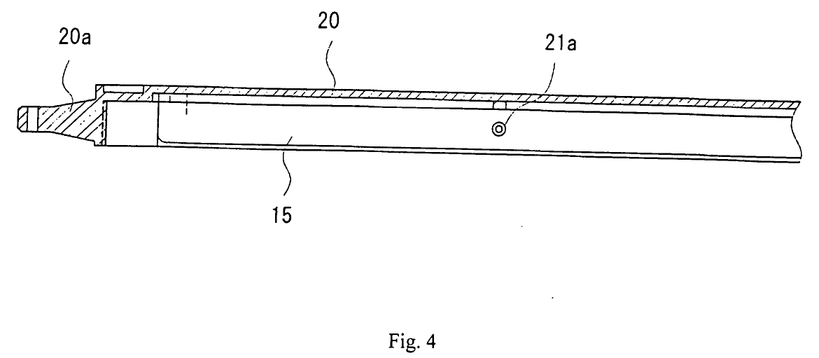

A female screw portion 21a (shown in FIG. 4) is formed in a part of the holding frame 21 (shown in FIG. 2) on the side opposite to the side supported by the projections 23 and faces the central part of the cylindrical mirror 15, and an adjustment screw 25 (shown in FIG. 1) is arranged as an adjustment device for exerting pressure for bow adjustment of the cylindrical mirror 15 by screwing the adjustment screw 25 into the female screw portion 21a. This adjustment screw 25 is allowed to pass through a through-hole 20b formed on the top of the mirror holder 20, and the head of the adjustment screw 25 is exposed to the outside. A force dispersion plate 26 is interposed between the tip of the adjustment screw 25 and the cylindrical mirror 15 to directly receive pressure from the tip of the adjustment screw and disperse the force over a wider area of the cylindrical mirror 15. The force dispersion plate 26 includes a rectangular section with the tip of the adjustment screw 25 at its center in its longitudinal direction, which is also the center of the longitudinal direction of the cylindrical mirror 15. Thus, the central part of the cylindrical mirror 15 is pressed along the entire longitudinal length of the force dispersion plate 26 by tightening the adjustment screw 25 against the force dispersion plate 26.

As shown in FIG. 1, the force dispersion plate 26 is formed with an L-shaped cross-section, with one leg of the L shape interposed between the adjustment screw 25 and the cylindrical mirror 15 and the other leg extending from one side of the holding frame 21 to the other side of the holding frame 21 and engaging a holding hole 20c formed in the mirror holder 20 in order to prevent the force dispersion plate from moving from its proper position on the mirror holder 20. The leg of the L shape interposed between the adjustment screw 25 and the cylindrical mirror 15 includes a lower planar surface that is in contact with the upper edge of the cylindrical mirror 15, as shown in FIG. 1. The upper edge of the cylindrical mirror 15 extends in the longitudinal direction.

Adjustment is made by the simple operation of tightening or loosening the adjustment screw 25. Because the L-shaped plate is interposed between the tip of the adjustment screw 25 and the cylindrical mirror 15 with a leg of the L-shaped plate including a planar surface that contacts the cylindrical mirror 15, the deformation force on the cylindrical mirror 15 is not concentrated at one point, and thus the risk of potential damage to the cylindrical mirror is reduced. Moreover, the cylindrical mirror is held by the mirror holder and protected on the top, bottom, back and both ends, and the correction of bow can be made together with the adjustment of inclination, magnification, and skew by providing the structure as described above. If inclination and skew are adjusted based on design values, fine adjustments can be made after the cylindrical mirror 15 is connected in its holding frame 21 to a chassis.

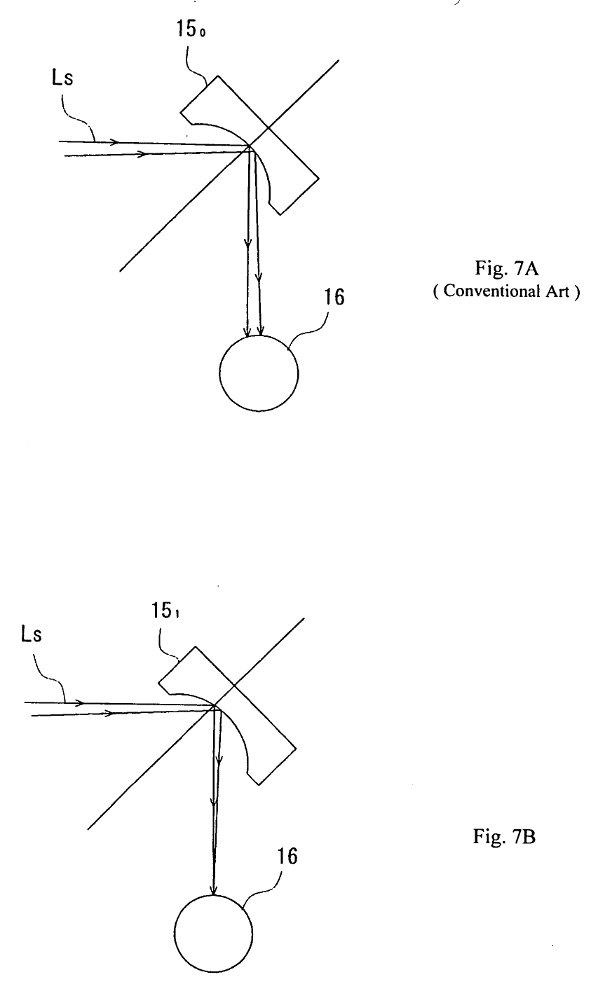

As discussed previously, as shown in FIG. 6, the scanning line S_{L} curves downward in the width direction of the cylindrical mirror 15. This is because the laser light beam is incident on the locus of deepest concavity of the cylindrical mirror 15 at the ends of the cylindrical mirror 15, but is incident below in the width direction the locus of deepest concavity between the ends of the cylindrical mirror, as shown in FIG. 7A. Also as shown in the FIG. 7A, this results in the light reflected by the cylindrical mirror 15 being incident at different positions in the circumferential direction at the surface of the photoreceptor drum 16. That is, bow at the cylindrical mirror produces bow at the photoreceptor drum.

However, if the cylindrical mirror 15 is changed from the state of FIG. 7A by tightening the adjustment screw 25 against the force dispersion plate 26, the central portion of the cylindrical mirror 15 is flexed downward, and its central portion in the longitudinal direction is pushed and flexes from the position 15₀ shown in FIG. 7A to the position 15₁ shown in FIG. 7B. That is, the cylindrical mirror 15 is deformed from its original unpressed shape in order to change the incident position of the scanning light beam Ls on the cylindrical mirror 15 and the incident angle of the scanning light beam Ls on the reflecting surface of the cylindrical mirror 15.

As discussed previously, the bow at the cylindrical mirror 15 is in the shape of a curved line as shown in FIG. 6. If the central portion of the cylindrical mirror in the longitudinal direction is pressed and deformed in the width direction, the cylindrical mirror 15 flexes almost symmetrically about the central portion. Therefore, the concave shape of the reflection surface of the cylindrical mirror 15 changes almost symmetrically about the central portion, thus changing the reflection point of the laser light beam and the angle of reflection from the cylindrical mirror 15 along the bow. Thus, as shown in FIG. 7B, the direction of reflection of the scanning light beam Ls in the central portion is adjusted to a direction such that the light is incident onto positions of the photoreceptor drum 16 that are not separated in the subscanning direction, that is, the circumferential direction of the photoreceptor drum 16, so that a straight scanning line is produced, as indicated by the straight line S₀ in FIG. 6, by adjusting the flexure of the central portion of the cylindrical mirror 15 by tightening the adjustment screw 25. Thus, bow of the scanning line at the photoreceptor drum 16 due to a light beam being incident on the deflection device 13 in an oblique direction may be reduced or eliminated by tightening the adjustment screw 25.

The present invention is not limited to the aforementioned embodiment, as it will be obvious that various alternative implementations are possible. For instance, in the embodiment explained above, a structure in which the adjustment screw 25 is arranged only in the central part of the cylindrical mirror 15 was explained, but other arrangements, including those with more contact points for flexing, may be used. Additionally, in the embodiment explained above, a cylindrical mirror was used, but mirrors of other shapes may be used. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A mirror and mirror holder comprising:
a mirror having a longitudinal direction and a width direction perpendicular to the longitudinal direction that define a plane perpendicular to a normal to the reflecting surface of the mirror, having a first surface extending in the longitudinal direction and perpendicular to the width direction, and having end portions at opposite ends in the longitudinal direction;
a mirror holder for supporting said mirror and protecting the mirror on the top, bottom and back sides as well as on both ends;
a force dispersion plate contained in the mirror holder that includes a surface arranged adjacent the upper edge of said mirror at a central portion of said mirror in the longitudinal direction of said mirror; and
an adjustment device in the mirror holder for pressing said surface of the force dispersion plate against the upper edge of the mirror so that the central portion of said mirror flexes in the width direction relative to end portions of the mirror held in the mirror holder.

2. The mirror and mirror holder of claim 1, wherein said mirror is a cylindrical mirror with its greater length extending in the longitudinal direction.

3. The mirror and mirror holder of claim 1, and further comprising
projections of the mirror holder, which support the bottom of the mirror near both ends of the mirror in the longitudinal direction; and
said adjustment device is installed in the central section of the longitudinal direction of the mirror holder, and presses against the top edge of the mirror.

4. The mirror and mirror holder of claim 3, wherein said mirror is a cylindrical mirror with its greater length extending in the longitudinal direction.

5. The mirror and mirror holder of claim 1, wherein
said force dispersion plate is L-shaped with one leg of the L-shaped plate providing said surface of the force dispersion plate and the other leg of the L-shaped plate engaging a hole formed in said mirror holder for maintaining the position of the L-shaped plate.

6. The mirror and mirror holder of claim 1, in combination with a light scanning device, said light scanning device comprising:
a light source that produces a light beam; and
a deflection device on which said light beam is incident in an oblique direction and that sequentially deflects the light beam in different directions in order to form a scanning line; wherein
said mirror reflects light deflected from the deflection device so as to form a scanning line on an object; and
said adjustment device flexes the central portion of said mirror in order to reduce or eliminate bow in the scanning line on said object due to said light beam being incident on said deflection device in an oblique direction.

7. The mirror and mirror holder of claim 2, in combination with a light scanning device, said light scanning device comprising:
a light source that produces a light beam; and
a deflection device on which said light beam is incident in an oblique direction and that sequentially deflects the light beam in different directions in order to form a scanning line; wherein
said mirror reflects light deflected from the deflection device so as to form a scanning line on an object; and
said adjustment device flexes the central portion of said mirror in order to reduce or eliminate bow in the scanning line on said object due to said light beam being incident on said deflection device in an oblique direction.

8. The mirror and mirror holder of claim 3, in combination with a light scanning device, said light scanning device comprising:
a light source that produces a light beam; and
a deflection device on which said light beam is incident in an oblique direction and that sequentially deflects the light beam in different directions in order to form a scanning line; wherein
said mirror reflects light deflected from the deflection device so as to form a scanning line on an object; and
said adjustment device flexes the central portion of said mirror in order to reduce or eliminate bow in the scanning line on said object due to said light beam being incident on said deflection device in an oblique direction.

9. The mirror and mirror holder of claim 4, in combination with a light scanning device, said light scanning device comprising:
a light source that produces a light beam; and
a deflection device on which said light beam is incident in an oblique direction and that sequentially deflects the light beam in different directions in order to form a scanning line; wherein
said mirror reflects light deflected from the deflection device so as to form a scanning line on an object; and
said adjustment device flexes the central portion of said mirror in order to reduce or eliminate bow in the scanning line on said object due to said light beam being incident on said deflection device in an oblique direction.

10. The mirror and mirror holder of claim 5, in combination with a light scanning device, said light scanning device comprising:
a light source that produces a light beam; and
a deflection device on which said light beam is incident in an oblique direction and that sequentially deflects the light beam in different directions in order to form a scanning line; wherein
said mirror reflects light deflected from the deflection device so as to form a scanning line on an object; and
said adjustment device flexes the central portion of said mirror in order to reduce or eliminate bow in the scanning line on said object due to said light beam being incident on said deflection device in an oblique direction.
